(19) United States
(12) Patent Application Publication
(10) Pub. No.: US 2009/0282177 A1
(43) Pub. Date: Nov. 12, 2009

(54) APPARATUS AND METHOD FOR SIGNAL TRANSMISSION IN EMBEDDED SYSTEM

(75) Inventors: Ying-Min Chen, Hsinchu City (TW); Shin-Hung Jou, Changhua County (TW); Chia-Min Ting, Taoyuan County (TW); Cheng-Min Chang, Keelung City (TW)

Correspondence Address: WPAT, PC, 7225 BEVERLY ST., ANNANDALE, VA, 22003, US

(73) Assignee: INDUSTRIAL TECHNOLOGY RESEARCH INSTITUTE, Hsin-Chu (TW)

(21) Appl. No.: 12/181,471

(22) Filed: Jul. 29, 2008

(30) Foreign Application Priority Data
May 8, 2008 (TW) 097116935

(51) Int. Cl. G06F 13/20

(52) U.S. Cl. 710/110

(57) ABSTRACT

An apparatus and a method for signal transmission in an embedded system. The apparatus comprises: a master control chip, embedded in the embedded system and comprising a controller and a plurality of I/O pins; a plurality of slave chips; and a bus having one end coupled to the plurality of I/O pins and the other end coupled to one of the plurality of slave chips; wherein data or signals are bi-directionally transmitted. The method comprises steps of: transmitting a control signal from a master control chip to a slave chip; starting an operation by the slave chip after receiving the control signal; transmitting a data signal and a command signal to the master control chip from the slave chip; processing the data signal according to the command signal by the master control chip; and transmitting another control signal from the master control chip to the slave chip to terminate the operation.

### BACKGROUND OF THE INVENTION

1. Field of the Invention

The present invention generally relates to an apparatus and a method for signal transmission in an embedded system and, more particularly, to an apparatus and a method for signal transmission combining serial transmission and parallel transmission to achieve bi-directional transmission of signal/data between chips with reduced lost, compactness, high scalability and excellent practicability.

2. Description of the Prior Art

The driver technology for the servo motor is one of the basis technologies in the industry. The development in the servo motor driver is focused on the embedded system, from the early day programmable logic controller (PLC) to the modern day digital signal processor (DSP) control chip. With the increase of the demand on functionality, the single DSP cannot meet the requirement for modern day demand. Therefore, the servo motor driver is often used with a micro-controller unit (MCU) or a field programmable gate array (FPGA) chip to improve the functionality as well as performance of the servo motor driver.

With the improvement in functionality as well as performance, the servo motor driver is implemented using a powerful processing chip, which is controlled by an embedded system. The interconnection between the embedded system and peripherals is limited by the pin count of the processing chip. Therefore, the number of chips on the control board of the driver has to be increased, which makes data transmission between the chips in the embedded system and the peripheral chips more important.

Currently, data transmission on an embedded system includes serial transmission and parallel transmission, wherein serial transmission takes longer transmission time with smaller pin count and reduced control board area, while parallel transmission takes shorter transmission time with larger pin count. In embedded chips, some chips provide pins for transmission between the data bus and the address bus. However, the pin count for such chips is larger. These pins are only for some specific functions and cannot be used elsewhere, which leads to a waste of pins and area.

Moreover, most chips do not comprise pins for the data bus and the address bus, and thus do not provide parallel transmission but serial transmission. Therefore, such chips cannot be used for the servo motor.

Two chips only communicate when transmission therebetween is available. The currently used transmission mode is mostly parallel transmission using the data bus and the address bus. Each bus used with the pins is 8-bit. Therefore, the data bus and the address bus totally occupy 32 pins of the two chips. As these pins are not used for specific purposes, they still cannot be used as general input/output (I/O) pins, while occupying a considerable amount of area, which increases the chip size and the manufacturing cost.

Therefore, there exists a need in providing an apparatus and a method for signal transmission in an embedded system, combining serial transmission and parallel transmission to achieve bi-directional transmission of signal/data between chips with reduced lost, compactness, high scalability and excellent practicability.

### SUMMARY OF THE INVENTION

The present invention provides an apparatus and a method for signal transmission in an embedded system, which uses chip select to achieve parallel transmission between the address bus and the data bus by I/O) pins. During transmission, the address bus and the data bus use the same pins for bi-directional transmission to achieve reduced cost and compactness. In the present invention, the address bus and the data bus are connected to the pins that can also be used as general I/O pins with variable bit length unlimited by the chip design so as to achieve high scalability and excellent practicability.

In one embodiment, the present invention provides an apparatus for signal transmission in an embedded system, comprising:

a master control chip embedded in the embedded system and comprising a plurality of general purpose I/O pins;

a plurality of slave chips, each of the slave chips comprising a plurality of I/O pins; and

a bus having a first end coupled to the general purpose I/O pins and a second end coupled to the I/O pins of each of the slave chips;

wherein the master control chip transmits signal/data to each of the slave chips through the bus, and a formatted signal/data capable of being analyzed by the one of the slave chips is different from at least a formatted signal/data format capable of being analyzed by another slave chip.

Preferably, the I/O pin count of one of the slave chips is different from the I/O pin count of at least another slave chip.

Preferably, one of the slave chips comprises I/O pins being general purpose I/O pins.

Preferably, one of the slave chips comprises I/O pins being I2C pins, and the master control chip transmits an I2C format data through the bus and the I2C pins so that the slave chip comprising the I2C pins receives the I2C format data.

Preferably, one of the slave chips comprises I/O pins comprising an enable pin, and the master control chip transmits an enable signal through the bus and the enable pin so that the slave chip comprising the enable pin is enabled.

Preferably, one of the slave chips comprises I/O pins comprising a control pin and data pins; the master control chip transmits a control signal through the bus and the control pin so that the slave chip comprising the control pin is a controllable slave chip; and the master control chip transmits a data signal through the bus and the data pin so that the controllable slave chip receives and analyzes the data signal.

In another embodiment, the present invention further provides a method for signal transmission in an embedded system comprising an apparatus for signal transmission, the apparatus comprising a master control chip, a slave chip and a bus, the method comprising steps of:

transmitting a control signal from the master control chip to the slave chip to start an operation by the slave chip;

transmitting a data signal and a command signal from the master control chip to the slave chip;

processing the data signal according to the command signal by the slave chip; and

transmitting another control signal from the master control chip to the slave chip to terminate the operation.

In still another embodiment, the present invention further provides a method for signal transmission in an embedded system comprising an apparatus for signal transmission, the apparatus comprising a master control chip, a slave chip and a bus, the method comprising steps of:

transmitting a control signal from the master control chip to the slave chip to start an operation by the slave chip;

transmitting a data signal and a command signal from the slave chip to the master control chip;

processing the data signal according to the command signal by the master control chip; and

transmitting another control signal from the master control chip to the slave chip to terminate the operation.

### BRIEF DESCRIPTION OF THE DRAWINGS

The objects, spirits and advantages of the preferred embodiments of the present invention will be readily understood by the accompanying drawings and detailed descriptions, wherein:

FIG. 1 is a schematic diagram of an apparatus for signal transmission according to the present invention;

FIG. 2 is a clock diagram of non-synchronous data transmission by an apparatus for signal transmission according to the present invention;

FIG. 3 shows three paths of data transmission according to the present invention;

FIG. 4A is a schematic diagram of an apparatus for signal transmission according to a first embodiment of the present invention, wherein a signal is transmitted from a master control chip;

FIG. 4B is a schematic diagram of an apparatus for signal transmission according to a first embodiment of the present invention, wherein a first-layer slave chip and a second-layer slave chip feedback a signal to a master control chip;

FIG. 5A is a schematic diagram of an apparatus for signal transmission according to a second embodiment of the present invention, wherein a specific format signal is transmitted from a master control chip;

FIG. 5B is a schematic diagram of an apparatus for signal transmission according to a second embodiment of the present invention, wherein a first-layer slave chip feedbacks a specific format signal to a master control chip;

FIG. 6A is a schematic diagram of an apparatus for signal transmission according to a third embodiment of the present invention, wherein a signal is transmitted from a master control chip;

FIG. 6B is a schematic diagram of an apparatus for signal transmission according to a third embodiment of the present invention, wherein a first-layer slave chip feedbacks a signal to a master control chip;

FIG. 7 is a flowchart showing a master control chip transmitting data to a slave chip according to the present invention; and

FIG. 8 is a flowchart showing a master control chip receiving data from a slave chip according to the present invention.

### DETAILED DESCRIPTION OF THE PREFERRED EMBODIMENT

The present invention can be exemplified by the embodiments as described hereinafter.

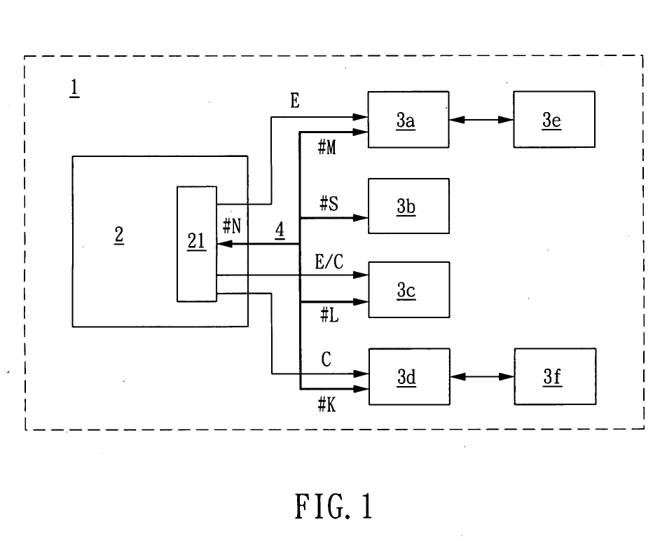

Please refer to FIG. 1, which is a schematic diagram of an apparatus for signal transmission according to the present invention. In FIG. 1, the apparatus 1 for signal transmission of the present invention comprises a master control chip 2, four first-layer slave chips 3a, 3b, 3c and 3d, two second-layer slave chips 3e, 3f and a bus 4. The master control chip 2 is embedded in an embedded system (not shown) and comprises a plurality of general purpose I/O pins (GPIO) 21. The master control chip 2 can be implemented by but not limited to a micro-controller chip, a digital signal processor or a programmable chip.

The apparatus 1 uses the general purpose I/O pins 21 of the master control chip 2 to be connected to the first-layer slave chips 3a, 3b, 3c and 3d or the second-layer slave chips 3e, 3f through the bus 4.

Taking the slave chip 3a for example, the slave chip 3a comprises a plurality of I/O pins. The slave chip 3a can be an application specific integrated circuit (ASIC) chip, a transmitter chip, a micro-controller chip, a digital signal processor chip, or a programmable chip. The I/O pins can be implemented by but not limited to general purpose I/O (GPIO) or I2C (inter-IC) pins.

The I2C pins meet the bi-directional two-wired serial bus standard. Devices comprising I2C interfaces use two wires therebetween to transmit data, which is more reliable and secure than parallel transmission and achieves reduced circuit board area and cost. The transmission rate is as high as 1M Bits/sec. The transmission distance is several meters and can be lengthened to tens of meters with an amplifier.

The signal/data is output from the I/O pins of the first-layer slave chips 3a, 3b, 3c and 3d or the second-layers slave chips chip 3e, 3f to control the parameters such as position, speed and torque of the servo motor (not shown).

The bus 4 has one end coupled to the general purpose I/O pins 21 of the master control chip 2 and the other end coupled to the I/O pins of the slave chips 3a, 3b, 3c, and 3d. The number of connected pins of the master control chip 2 and the slave chips 3a, 3b, 3c and 3d can be adjusted according to the pins of the chips. Some of the pins can be shared. For example, the pin count of the master control chip 2 is N, while the pin count of the first-layer slave chips 3a, 3b, 3c and 3d is M, S, L and K, respectively, wherein N, M, S, L and K are not necessarily identical. Therefore, there is flexibility in the use of the present invention to achieve high scalability and excellent practicability.

A formatted signal/data capable of being analyzed by the one of the first-layer slave chips 3a, 3b, 3c and 3d is different from at least a formatted signal/data capable of being analyzed by another slave chip. Taking the first-layer slave chip 3b for example, when the master control chip 2 selects to transmit the signal/data capable of being analyzed by the slave chip 3b to the first-layer slave chips 3a, 3b, 3c and 3d through the general purpose I/O pins 21 and the bus 4, the first-layer slave chip 3b starts to operate according to the signal, while the other slave chips 3a, 3c and 3d idle because only the slave chip 3b is capable of analyzing the signal/data. Moreover, the signal/data of the first-layer slave chip 3b can be transmitted to the master control chip 2 through the bus 4 to achieve bi-directional transmission. The detailed operation is described hereinafter.

In the present invention, the master chip 2 is implemented using a DSP or micro-controller chip. The slave chips 3a, 3b, 3c and 3d are implemented using FPGA chips to achieve optimal performance because FPGA chips provide designing flexibility in formats for data transmission. Considering the functionality as well as the performance demanded by the driver (servo motor) in an embedded system, the currently available processor chips are mostly implemented using DSP ASIC chips, while the peripheral controller chips are mostly implemented using FPGA chips since the ASIC chips are costly. The number of peripheral chips can be further increased to achieve reduced cost, compactness, high scalability and excellent practicability.

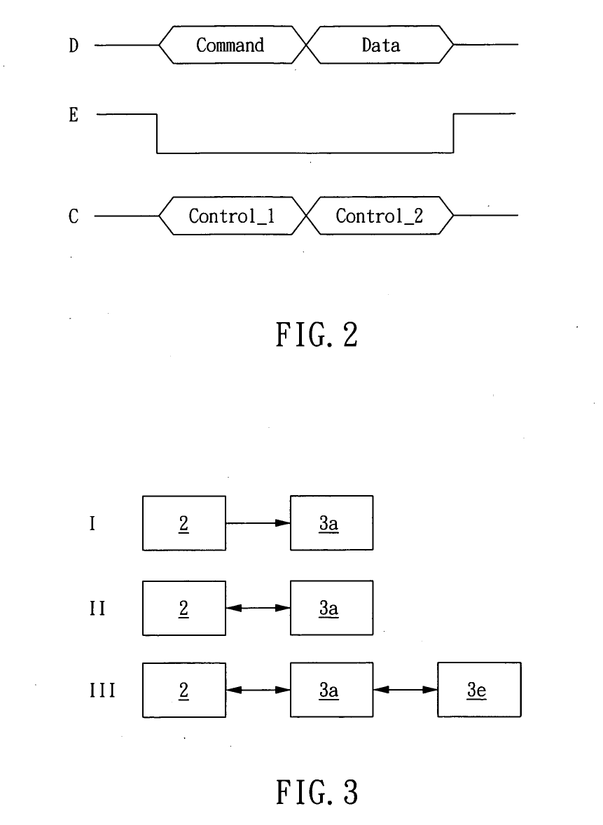

In the aforesaid apparatus for signal transmission of the present invention, the data can be transmitted using synchronous/non-synchronous transmission. Please further refer to FIG. 1 and FIG. 2, wherein FIG. 2 is a clock diagram of non-synchronous data transmission by an apparatus for signal transmission according to the present invention. An enable signal E and a control signal C are used to transmit data signals through data transmission lines without limiting the number of the data transmission lines. The data transmission order is not restricted. The user can first transmit a command and then transmit a data, or first transmit a data and then transmit a command. The control signal is capable of distinguishing the command signal and the data signal, and is capable of controlling the operation of other chips.

The master control chip transmits a command and a data to the slave chip. After the slave chip receives the command and the data, the slave chip operates according to the received command and data. If the slave chip is a FPGA chip, the FPGA chip controls other slave chips according to the command from the master control chip. Alternatively, the FPGA chip can also transmit data to the master control chip. In other words, the direction for data transmission is not limited. If the slave chip receives a command and a data for transmitting data from the slave chip to the master control chip, the slave chip feedbacks the data requested by the master control chip to the master control chip to achieve bi-directional transmission.

Therefore, with the aforesaid data transmission approaches combined, please refer to FIG. 3, which shows three paths of data transmission according to the present invention. Taking the first-layer slave chip 3a and the second-layer slave chip 3e for example, in path I, the data and the command are transmitted from the master control chip 2 to the slave chip 3a. In path II, the data and the command are transmitted from the master control chip 2 to the slave chip 3a, while the slave chip 3a feedbacks the data to the master control chip 2. In path III, the master control chip 2 performs command and data transmission with the first-layer slave chip 3a and the second-layer slave chip 3e.

Using the schematic diagram as shown in FIG. 1 with data transmission approaches in FIG. 3, the present invention is exemplified by but not limited to the embodiments.

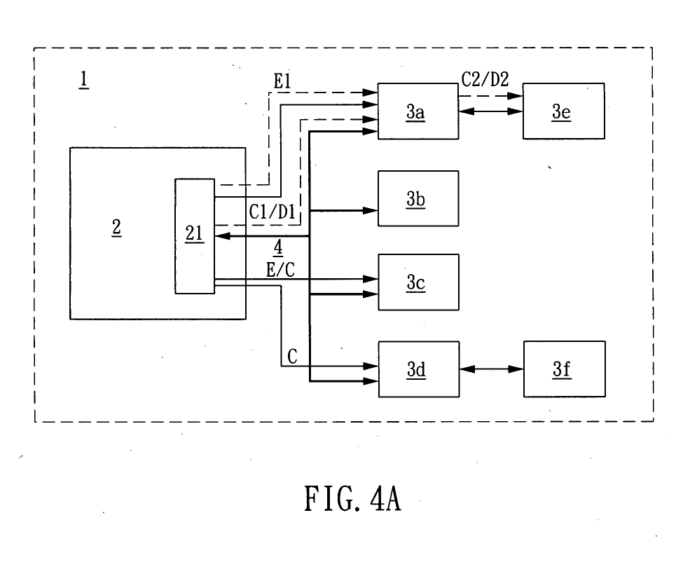

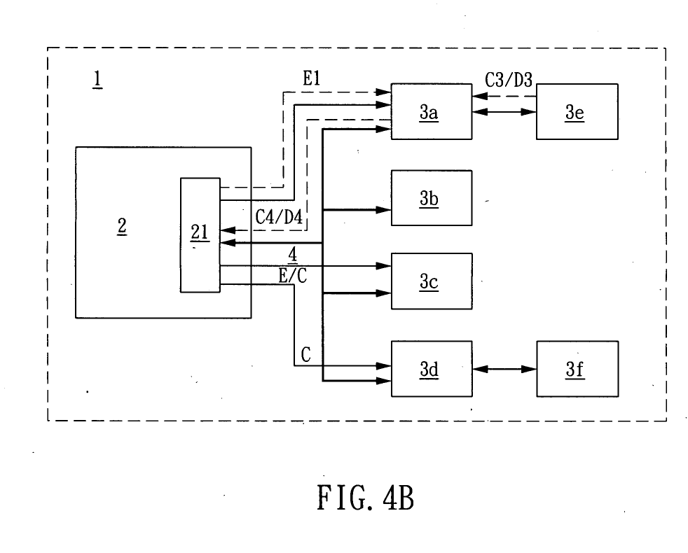

Please refer to FIG. 4A and FIG. 4B. FIG. 4A is a schematic diagram of an apparatus for signal transmission according to a first embodiment of the present invention, wherein a signal is transmitted from a master control chip. FIG. 4B is a schematic diagram of an apparatus for signal transmission according to a first embodiment of the present invention, wherein a first-layer slave chip and a second-layer slave chip feedback a signal to a master control chip. First, the master control chip 2 transmits an enable signal E1 capable of being analyzed by a slave chip 3a to first-layer slave chips 3a, 3b, 3c and 3d. Since only the slave chip 3a is able to analyze the enable signal E1, the other first-layer slave chips 3b, 3c and 3d are disabled. With the bus 4 comprising general purpose I/O pins, a control signal C1 and a data D1 are transmitted to the first-layer slave chip 3a. After the first-layer slave chip 3a receives the control signal C1 and the data D1, the first-layer slave chip 3a operates according to the control signal C1 and the data D1 to transmit a control signal C2 and a data D2 to the second-layer slave chip 3e and transmit a control signal C3 and a data D3 from the second-layer slave chip 3e to the first-layer slave chip 3a. At last, a control signal C4 and a data D4 are transmitted to the master control chip 2 to complete signal transmission between the master control chip and the slave chips.

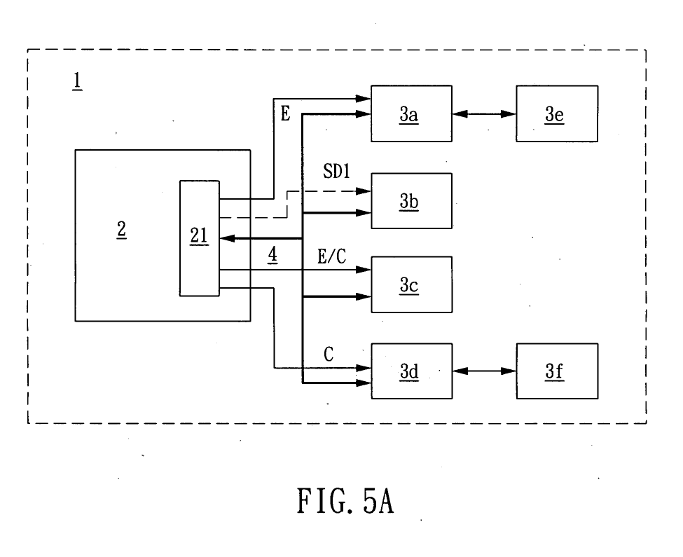

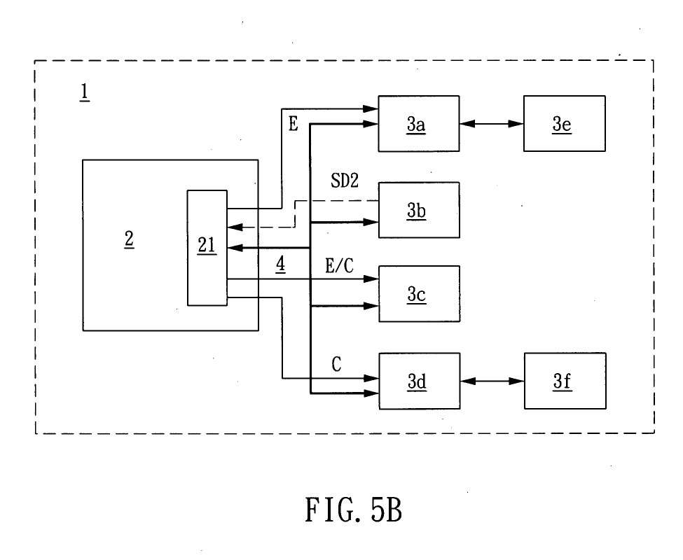

Please refer to FIG. 5A and FIG. 5B. FIG. 5A is a schematic diagram of an apparatus for signal transmission according to a second embodiment of the present invention, wherein a specific format signal is transmitted from a master control chip. FIG. 5B is a schematic diagram of an apparatus for signal transmission according to a second embodiment of the present invention, wherein a first-layer slave chip feedbacks a specific format signal to a master control chip. First, the master control chip 2 transmits a specifically formatted signal SD1 (exemplified by I2C format) capable of being analyzed by a slave chip 3b to first-layer slave chips 3a, 3b, 3c and 3d. Since the other first-layer slave chips 3a, 3c and 3d are not able to analyze the specifically formatted signal SD1, these first-layer slave chips 3a, 3c and 3d will not perform processing on the specifically formatted signal SD1. Therefore, it is impossible to for the master control chip 2 to transmit such a specifically formatted signal SD1 to any non-targeted slave chip to cause error operation and response. After the first-layer slave chip 3b receives the specifically formatted signal SD1 and analyzes it according to the signal content, the master control chip 2 will receive a specifically formatted signal SD2 from the first-layer slave chip 3b, if necessary, to achieve bi-directional transmission.

Taking an I2C formatted signal for example, when the master control chip 2 transmits the I2C formatted signal to the slave chip 3b comprising I2C pins, the slave chip 3b has to comprise an only address that is an even number, and the master control chip 2 has to broadcast to the I2C device (i.e., the slave chip comprising I2C pins) and transmit the address of the elements to be communicated. The corresponding slave chip 3b starts to communicate and perform data transmission with the master control chip 2, while the other slave chips 3a, 3c and 3d idle. After the communication is completed, the slave chip 3b returns to its initial state and waits for a next operation. The I2C communication process between the master control chip 2 and the slave chip 3b is initiated by transmitting an address (even-numbered) when the master control chip 2 is to write data into the slave chip 3b. When the master control chip 2 is to read the slave chip 3b, an odd-numbered address is transmitted. In other words, 7 MSB's (most significant bits) of a byte are used to represent the address, while the LSB (least significant bit) represents the read/write operation.

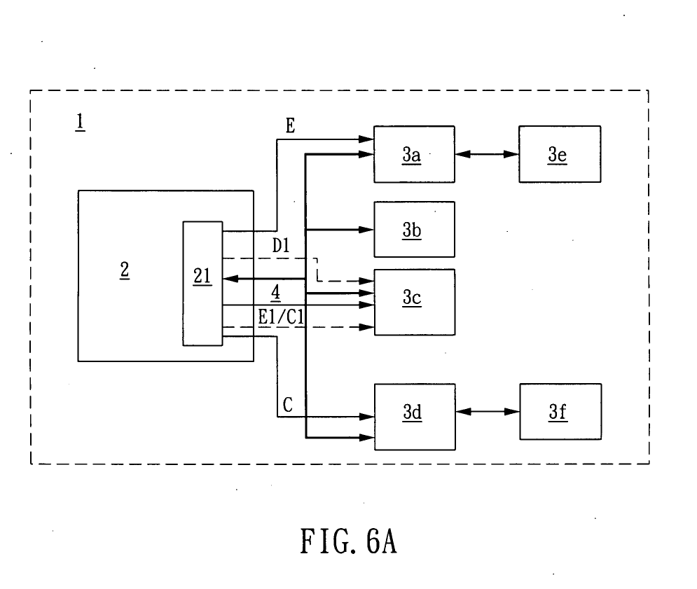

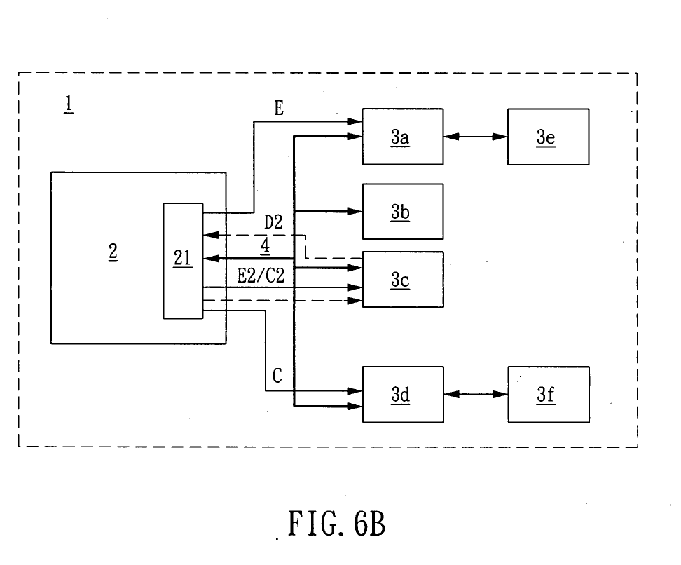

Please refer to FIG. 6A and FIG. 6B. FIG. 6A is a schematic diagram of an apparatus for signal transmission according to a third embodiment of the present invention, wherein a signal is transmitted from a master control chip. FIG. 6B is a schematic diagram of an apparatus for signal transmission according to a third embodiment of the present invention, wherein a first-layer slave chip feedbacks a signal to a master control chip. First, the master control chip 2 transmits an enable signal E1 or a control signal C1 capable of being analyzed by a slave chip 3C to first-layer slave chips 3a, 3b, 3c and 3d to enable or control the first-layer slave chip 3c, while the other first-layer slave chips 3a, 3b and 3d are disabled or uncontrolled. Then, the master control chip 2 transmits a data D1 to the first-layer slave chip 3c. The first-layer slave chip 3c starts to operate according to the content of the data D1 after it analyzes the data D1. Otherwise, the master control chip 2 transmits another enable signal E2 and control signal C2 to the first-layer slave chip 3c to enable or control the first-layer slave chip 3c so that the first-layer slave chip 3c transmits the data D2 back to the master control chip 2 to complete bi-directional data transmission.

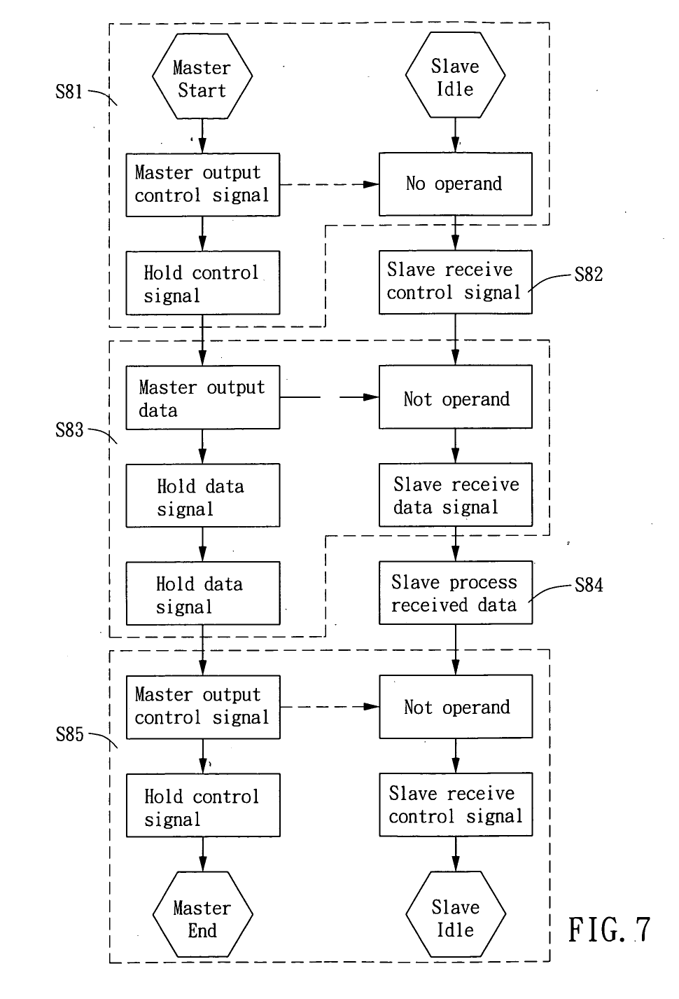

Please refer to FIG. 7, which is a flowchart showing a master control chip transmitting data to a slave chip according to the present invention, comprising steps described hereinafter.

Step S81: A master control chip transmits a control signal to a slave chip to start an operation by the slave chip.

Step S82: The slave chip starts after receiving the control signal.

Step S83: The master control chip transmits a data signal and a command signal to the slave chip.

Step S84: The slave chip processes the data signal according to the command signal.

Step S85: The master control chip transmits another control signal to the slave chip to terminate the operation.

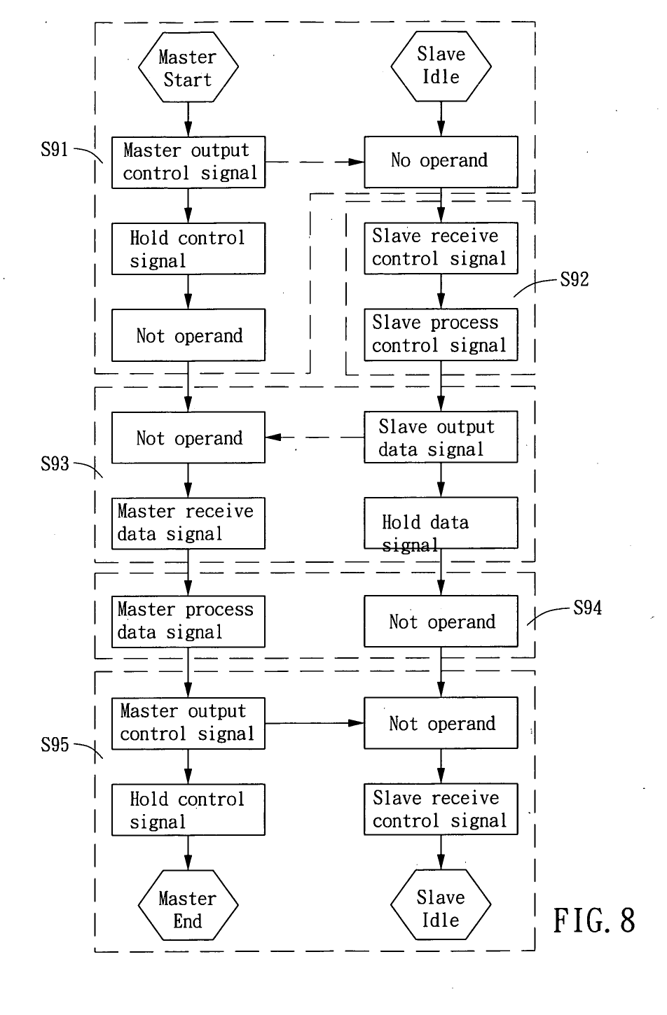

Please further refer to FIG. 8, which is a flowchart showing a master control chip receiving data from a slave chip according to the present invention, comprising steps described hereinafter.

Step S91: A master control chip transmits a control signal to a slave chip to start an operation by the slave chip.

Step S92: The slave chip starts after receiving the control signal.

Step S93: The slave chip transmits a data signal and a command signal to the master control chip.

Step S94: The master control chip processes the data signal according to the command signal.

Step S95: The master control chip transmits another control signal to the slave chip to terminate the operation.

Accordingly, the general purpose I/O pins of the master control chip in the embedded system of the present invention are coupled to the first-layer slave chip and/or the second-layer slave chip through the bus. Therefore, the present invention has advantages described hereinafter.

(1) A combination of serial transmission and parallel transmission: The transmitted data comprises a control command and a data command that are transmitted to the slave chip in turn (i.e., serial transmission). Meanwhile, the data is transmitted to the slave chip in a multi-bit format using a plurality of transmission lines in the bus (i.e., parallel transmission). Therefore, reduced lost as well as compactness is achieved.

(2) Since general purpose I/O pins are used for transmission, these pins can also be connected to other chips (comprising specific purpose pins) for other purposes to achieve high scalability and excellent practicability.

Accordingly, the present invention discloses an apparatus and a method for signal transmission for a servo motor with reduced lost, compactness, high scalability and excellent practicability. Therefore, the present invention is novel, useful and non-obvious.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. An apparatus for signal transmission in an embedded system, comprising:
a master control chip embedded in the embedded system and comprising a plurality of general purpose I/O pins;
a plurality of slave chips, each of the slave chips comprising a plurality of I/O pins; and
a bus having a first end coupled to the general purpose I/O pins and a second end coupled to the I/O pins of each of the slave chips;
wherein the master control chip transmits signal/data to each of the slave chips through the bus, and a formatted signal/data capable of being analyzed by the one of the slave chips is different from at least a formatted signal/data capable of being analyzed by another slave chip.

2. The apparatus for signal transmission as recited in claim 1, wherein the I/O pin count of one of the slave chips is different from the I/O pin count of at least another slave chip.

3. The apparatus for signal transmission as recited in claim 1, wherein one of the slave chips comprises I/O pins being I2C pins.

4. The apparatus for signal transmission as recited in claim 3, wherein the master control chip transmits an I2C format data through the bus and the I2C pins so that the slave chip comprising the I2C pins receives the I2C format data.

5. The apparatus for signal transmission as recited in claim 1, wherein one of the slave chips comprises I/O pins being general purpose I/O pins.

6. The apparatus for signal transmission as recited in claim 1, wherein one of the slave chips comprises I/O pins comprising an enable pin.

7. The apparatus for signal transmission as recited in claim 6, wherein the master control chip transmits an enable signal through the bus and the enable pin so that the slave chip comprising the enable pin is enabled.

8. The apparatus for signal transmission as recited in claim 1, wherein one of the slave chips comprises I/O pins comprising a control pin and data pins.

9. The apparatus for signal transmission as recited in claim 8, wherein the master control chip transmits a control signal through the bus and the control pin so that the slave chip comprising the control pin is a controllable slave chip.

10. The apparatus for signal transmission as recited in claim 9, wherein the master control chip transmits a data signal through the bus and the data pin so that the controllable slave chip receives and analyzes the data signal.

11. The apparatus for signal transmission as recited in claim 1, wherein the master control chip is a micro-controller chip, a digital signal processor chip or a programmable chip.

12. The apparatus for signal transmission as recited in claim 1, wherein one of the slave chips is an application specific integrated circuit (ASIC) chip, a transmitter chip, a micro-controller chip, a digital signal processor chip or a programmable chip.

13. A method for signal transmission in an embedded system comprising an apparatus for signal transmission, the apparatus comprising a master control chip, a slave chip and a bus, the method comprising steps of:
transmitting a control signal from the master control chip to the slave chip to start an operation by the slave chip;
transmitting a data signal and a command signal from the master control chip to the slave chip;
processing the data signal according to the command signal by the slave chip; and
transmitting another control signal from the master control chip to the slave chip to terminate the operation.

14. A method for signal transmission in an embedded system comprising an apparatus for signal transmission, the apparatus comprising a master control chip, a slave chip and a bus, the method comprising steps of:
transmitting a control signal from the master control chip to the slave chip to start an operation by the slave chip;
transmitting a data signal and a command signal from the slave chip to the master control chip;
processing the data signal according to the command signal by the master control chip; and
transmitting another control signal from the master control chip to the slave chip to terminate the operation.
